(19) United States
(12) Patent Application Publication
(10) Pub. No.: US 2018/0126298 A1
(43) Pub. Date: May 10, 2018

(54) DEVICE FOR SUBSTANCE SEPARATION

(71) Applicant: Merck Patent GmbH, Darmstadt (DE)

(72) Inventors: Karin CABRERA, Dreieich (DE); Klaus KREHER, Muenster (DE); Gisela JUNG, Weiterstadt (DE)

(73) Assignee: Merck Patent GmbH, Darmstadt (DE)

(21) Appl. No.: 15/575,540

(22) PCT Filed: May 2, 2016
(86) PCT No.: PCT/EP2016/000718

§ 371 Date: Nov. 20, 2017

(30) Foreign Application Priority Data
May 22, 2015 (EP) 15001559.2

(51) Int. Cl. B01D 15/08; B01J 20/26; B01J 20/28; B01J 20/285; C08G 65/40; C08G 75/0209

(52) U.S. Cl. CPC B01D 15/08; B01J 20/262; B01J 20/28042; G01N 2030/528; C08G 65/4012; C08G 75/0209; B01J 2220/82; B01J 20/285

(57) ABSTRACT

The invention relates to a device for substance separation with monolithic sorbents which can be produced by means of 3-D printing. They comprise pressure- and solvent-stable thermoplastics.

The invention relates to devices for substance separation containing monolithic materials which can be produced by means of 3-D printing. They consist of pressure- and solvent-stable thermoplastics.

Monolithic materials are used, for example, as chromatography column in chromatography. They are also used in other areas of substance separation, such as, for example, in sample preparation and extraction. For the production of conventional chromatography columns containing particulate sorbents, the filling material is introduced into a stainless steel or plastic tube with tight-fitting ends. This results in the sorbent bed being in close contact with the wall of the column and the particles being homogeneously distributed over the entire cross section of the column.

Conventional materials for sample preparation likewise consist of a particulate filling material, which is introduced into suitable plastic cartridges, stainless steel tubes or other devices, such as, for example, so-called 96-well plates. The filling materials consist of inorganic or organic-polymeric particles.

If, as disclosed, for example, in WO 94/19 687 and in WO 95/03 256, particulate sorbents are replaced by monolithic sorbents, continuous, 3-dimensional, porous mouldings, also called porous monolithic mouldings, are obtained, which can be employed for chromatographic separation or sample preparation. For use in chromatographic separations, the mouldings are provided with a liquid-tight and pressure-stable cladding. Only in this way is it ensured that sample and eluent are transported exclusively through the sorbent. The same also applies to applications in sample preparation.

The quality of a monolithic column for HPLC can be described via the separation efficiency (N/m) on the one hand and via the peak symmetry on the other hand. In the ideal case, the peak shape corresponds to a Gaussian bell shape. Deviations from this symmetrical shape result in “fronting” or “tailing”.

It has now been proposed to employ the technique of 3-D printing, also called additive manufacturing or prototyping, as process for the production of monolithic sorbents for chromatography and sample preparation. Conan Fee et al., Journal of Chromatography A, 1333 (2014) 18-24, demonstrate first porous mouldings having pores, which they propose for use in chromatography. However, it was not possible to demonstrate substance separation. Only the retardation of the elution of individual compounds is disclosed.

The object of the present invention was therefore to provide mouldings which can be produced by means of 3-D printing processes which are suitable for various applications of substance separation using a large selection of organic and aqueous solvents. In particular, mouldings produced in this way should also facilitate chromatographic separation of two or more compounds.

It has been found that, for example, chromatographic separation can be achieved if the porous mouldings which can be produced by means of 3-D printing consist of certain pressure- and solvent-stable plastics.

The present invention therefore relates to devices for substance preparation at least comprising a porous monolithic moulding as sorbent, characterised in that the moulding has been produced from a thermoplastic polymer by means of 3-D printing processes. The device preferably also comprises a cladding or, for extraction, at least one holder.

In a preferred embodiment, the device for substance separation is a chromatography column.

In a preferred embodiment, the thermoplastic polymer is selected from the group of the polyether imides, polyarylates, polyether ketones, polyesters, polyamides, polyimides, polyamide imides, polybenzimidazoles, polyphenylene sulfides, polyphenyl sulfones or polyoxymethylene as well as mixtures of two or more of these materials.

In a preferred embodiment, the thermoplastic polymer has a melting point above 150° C.

In a particularly preferred embodiment, the thermoplastic polymer is PEEK (polyether ether ketone) or PPS (polyphenylene sulfide).

In a further preferred embodiment, the thermoplastic polymer comprises additives.

In a preferred embodiment, the additives are fibre materials, inorganic materials or pigments, for example chalk, talc, mica or inorganic oxides, such as silicon dioxide, aluminium oxide, silicon carbide, glass or carbon fibres, preferably silicon dioxide, aluminium oxide, titanium dioxide, zirconium oxide, or silicon carbide or mixtures thereof, particularly preferably silicon dioxide.

In a preferred embodiment, the monolithic mouldings for substance separation consist at least of a porous monolithic moulding and a cladding which have been produced by means of 3-D printing processes.

In one embodiment, the cladding is a tube which surrounds the porous columnar moulding.

In another embodiment, the cladding has the shape of a cuboid or a plate into which the porous moulding has been introduced.

In a preferred embodiment, the porous monolithic moulding has a bimodal or oligomodal pore distribution.

In a particularly preferred embodiment, the porous monolithic moulding has macropores having a diameter between 0.1 and 10,000 μm which serve as through-flow pores, and mesopores having a pore diameter between 2 and 500 nm.

The present invention also relates to the use of a device according to the invention for the separation of at least two substances.

In a preferred embodiment, a chromatography column is used for the chromatographic separation of at least two substances.

In one embodiment, the chromatographic separation is carried out at temperatures above 30° C.

The present invention also relates to a process for the chromatographic separation of at least two substances, in which the sample comprising the substances to be separated is applied to a chromatography column according to the invention, the latter is rinsed with an eluent after the sample application, and the substances, which are retained to different extents on the sorbent during the treatment with eluent, are eluted successively and thus separated. The chromatography column according to the invention can have all properties disclosed above or below.

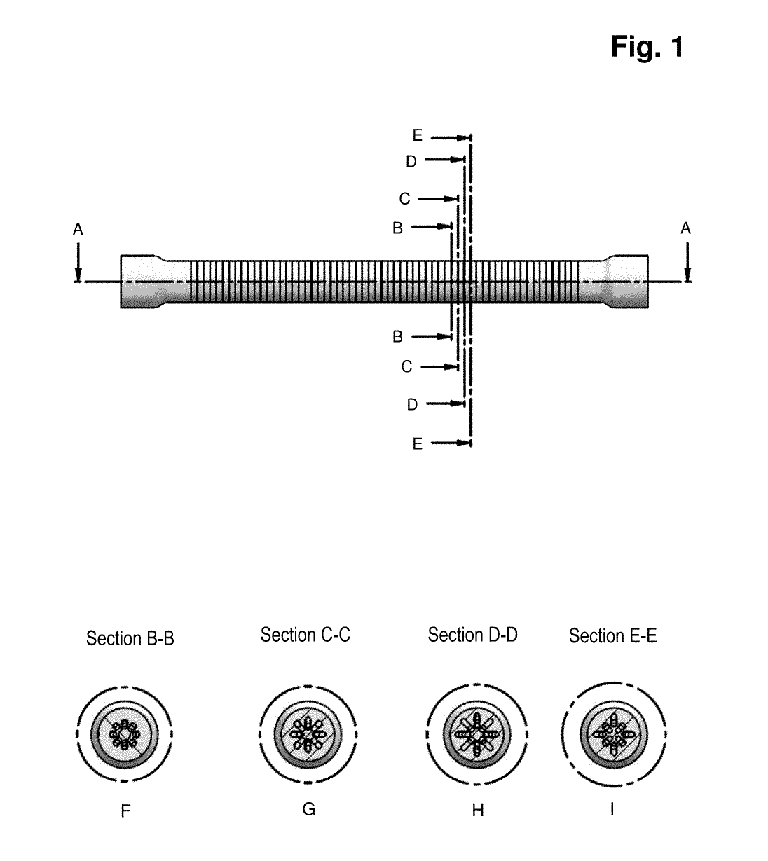

FIGS. 1 to 3 and 8 to 10 show diagrammatically sections from the CAD files used for the 3-D printing. Further details can be found in Examples 2 and 7.

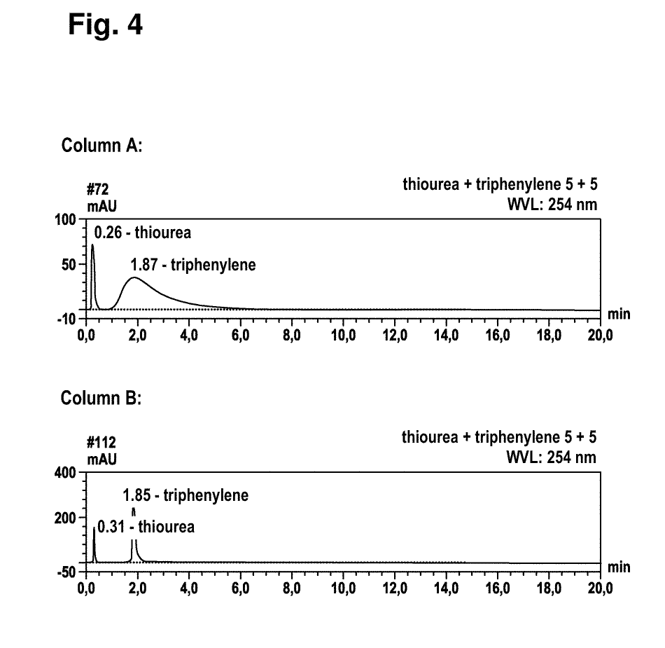

FIG. 4 shows chromatograms of a separation carried out using a column according to the invention compared with a separation using a conventional monolithic chromatography column. Further details can be found in Example 3.

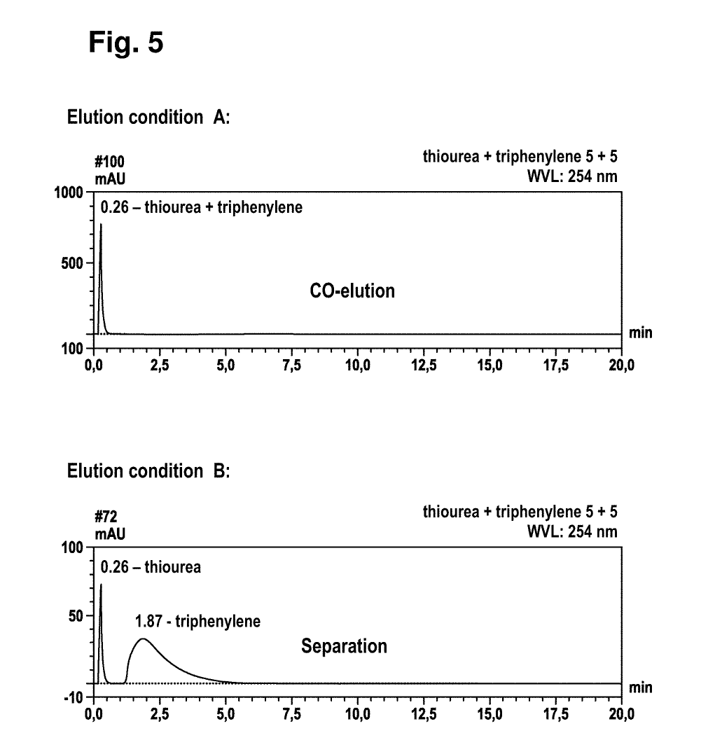

FIGS. 5 to 7 and 11 show chromatograms which were obtained on use of the chromatography columns according to the invention under various conditions. Further details can be found in Examples 4 to 6 and 8.

Devices for substance separation comprise at least one monolithic, porous sorbent, also called moulding, and preferably a cladding, which ensures that the sample to be separated, optionally mobile phases, wash solutions, etc., flow through the porous sorbent. The cladding can be, for example, a cartridge, a tube or another device, such as a pipette tip or so-called well plates, for example a 96-well plate. In accordance with the invention, substance separation means that two components or substances in a sample are separated from one another. This can take place by chromatographic separation or, for example, by extraction, such as SPE (solid phase extraction) or SPME (solid phase microextraction).

In accordance with the invention, chromatography columns comprise at least one monolithic, porous sorbent, also called moulding and a cladding, which ensures that, for example, the mobile phase flows through the porous sorbent. Chromatography columns, their structure and their use are known to the person skilled in the art. They typically additionally have connections for the inflow and outflow of sample, mobile phase, etc.

The chromatography column according to invention comprises at least one porous, monolithic moulding comprising a thermoplastic polymer which has been produced by means of 3-D printing processes and a cladding.

The porous, monolithic mouldings, also called porous mouldings or mouldings below, can have any desired shape. They are preferably columnar, i.e. cylindrical. Typical diameters are between 0.5 mm and 20 cm.

In accordance with the invention, a cladding is an enclosure which at least partly surrounds the porous moulding. If the moulding is a columnar moulding, the cladding typically surrounds the entire surface shell of the column. Connection possibilities for solvent inflow and outflow to the porous moulding serving as sorbent are typically located at both ends.

In accordance with the invention, any cladding known for monolithic chromatography columns, for example made from plastic, stainless steel and/or glass, can be used. The cladding can be applied to the moulding by means of conventional processes for the cladding of monolithic chromatography columns, as described, for example, in EP 0990153, U.S. Pat. No. 6,863,820 or WO 2008/098659. However, the cladding is preferably produced together with the porous moulding by means of 3-D printing processes and is made of the same material as the porous moulding. The connections, for example screw threads, for solvent inflow and outflow to the porous moulding can be introduced at the same time in the 3-D printing process.

In one embodiment, the cladding has the shape of a non-porous tube which surrounds the columnar porous moulding. In another embodiment, the cladding has a different shape, for example the shape of a cuboid or a plate into which the porous moulding has been introduced. In particular if the cladding is produced together with the porous moulding by means of 3-D printing processes, the shape of the cladding can be chosen as desired. An embodiment which is preferred besides the classical tube is a plate, card or flat moulding. Mouldings of this type are also called chips. In accordance with the invention, the porous moulding here is surrounded by a non-porous flat moulding. Connections for solvent inflow and outflow to the porous moulding are typically located in the flat moulding. In the case of devices according to the invention in the form of chips, the sorbent, i.e. the porous moulding, may have been introduced, for example, in columnar form into the cladding, two or more independent columnar porous mouldings may have been introduced or porous mouldings which have one or more branches. The porous moulding has then typically been introduced into the cladding as a straight, curved or branched channel.

In accordance with the invention, the porous mouldings have a monomodal, bimodal or oligomodal pore structure. They preferably have at least macropores having a diameter greater than 0.1 μm, which serve as through-flow pores. The macropores typically have diameters between 0.1 and 10,000 μm, preferably between 0.5 and 1000 μm. In a preferred embodiment, the moulding has a bimodal or oligomodal pore distribution, in which, in addition to the macropores, mesopores having a pore diameter between 2 and 500 nm, preferably between 5 and 100 nm, for example, are also present. In a particularly preferred embodiment, the mesopores are located in the walls of the macropores and thus increase the surface area of the moulding.

Through-flow pores are pores or channels which allow the through-flow of, for example, a liquid or a gas through a moulding. The liquid can enter the moulding here at one point and exit it again at another point. In the case of columnar mouldings, the liquid preferably enters at one end of the column and exits again at the other end. Correspondingly, pores which are located only in the form of a notch in the surface of a moulding are not through-flow pores.

The diameters of the macropores are typically measured by means of mercury porosimetry, while the diameters of the mesopores are determined by means of nitrogen adsorption/desorption by the BET method.

The total pore volume of the mouldings according to the invention is typically between 0.5 ml/g and 10 ml/g, preferably between 1 ml/g and 8 ml/g. The surface area of the mouldings according to the invention is typically between 1 m²/g and 750 m²/g, preferably between 10 m²/g and 500 m²/g.

3-D printing is a technology by means of which three-dimensional mouldings are built up in layers. The build-up is generally carried out under computer control in accordance with dimensions and shapes pre-specified from a virtual model (CAD=computer aided design). By means of CAD, a layer image of the desired moulding is typically created in digitalised form. To this end, porous slice elements are typically constructed on the screen by means of suitable software. These porous slice elements are then arranged one above the other until they give rise to a porous monolithic moulding having a defined dimension (for example 50×3 mm or 100×4.6 mm). The 3-D printing can be carried out using one or more liquid or solid substances. In the case of build-up layer by layer, physical or chemical curing or melting processes take place at the points of each layer that are to be solidified or joined. 3-D printing is a generative manufacturing process.

The principle and performance of 3-D printing are known to the person skilled in the art.

The most important techniques of 3-D printing are selective laser melting and electron beam melting, which are suitable, in particular, for metals, and selective laser sintering for polymers, ceramics and metals, stereolithography and digital light processing for liquid synthetic resins and polyjet modelling, also called multijet modelling, and fused deposition modelling for plastics and in some cases synthetic resins. The porous monolithic mouldings according to the invention are preferably made by means of stereolithography, selective laser sintering or polyjet modelling.

In stereolithography, a light-curing material is typically irradiated with a focused laser. The material, for example epoxy resin, is cured by a laser in thin layers (standard layer thickness in the range 0.05-0.25 mm, in the case of microstereolithography also up to 1 micron layers). The procedure takes place in a bath filled with the base monomers of the light-sensitive (photosensitive) material, typically a plastic. After each step, the workpiece is lowered a few millimetres into the liquid and moved back to a position which is about the amount of one layer thickness below the previous one. The liquid plastic over the part is then uniformly distributed by a wiper. A laser, which is controlled by a computer via movable mirrors, then moves on the new layer over the areas to be cured. After curing, the next step takes place, so that a three-dimensional model forms little by little.

In the case of selective laser sintering, the three-dimensional moulding is built up from a pulverulent material. Firstly, a thin layer of the powder material is applied to a build platform. The application can be carried out, for example, by means of a blade or roller. A strong laser beam, for example CO₂ laser, an Nd:YAG laser or a fibre laser, melts the powder precisely at the points specified by the computer-generated component construction data (CAD file). The construction platform then lowers, and a further application of powder takes place. The material is re-melted and bonds to the underlying layer at the defined points.

In polyjet modelling, the three-dimensional moulding is built up layer by layer by one or more print heads having preferably a plurality of nozzles arranged in a linear manner which function in a similar way to the print head of an ink-jet printer.

Suitable starting materials are liquid or liquefiable solids, such as hard waxes or special wax-like thermoplastics, as well as fusible plastics.

A variant of multijet modelling is to apply an adhesive to a pulverulent substrate by the ink-jet process.

To this end, in a tank with a lowerable platform, the substrate is, in a similar manner to selective laser sintering, applied layer by layer to the platform.

After each applied layer, the adhesive is then sprayed onto the areas which belong to the finished model.

In accordance with the invention, the 3-D printing is preferably carried out by means of selective laser sintering.

Plastics which are suitable for the devices according to the invention, such as chromatography columns and sample preparation materials, are thermoplastic polymers having a melting point of preferably >150° C., such as, for example, polyarylates (Ardel), polyether ketones (PEEK), polyesters (PET, PC, PBT), polyamides (PA), polyimides (PI), polyether imide (PEI) polyamide imides (PAI) polybenzimidazoles (PBI), polyphenylene sulfides (PPS), polyphenyl sulfones (PSU, PPSU) or polyoxymethylene (POM) as well as mixtures of two or more of these materials. In each case, suitable examples of the respective substance group are indicated in the brackets. Besides different viscosities, these materials exhibit, in particular, different chemical stability, such as, for example, solvent stability. The choice of suitable plastic therefore also depends on the chemical stability later required. It has been found that PEEK (polyetheretherketone) or polyphenylene sulfide (PPS) exhibit particularly advantageous properties in the production of the devices according to the invention for substance separation and in the use thereof. These materials are also suitable, in particular, for the demands of chromatography columns with respect to chemical stability and also pressure stability.

The melting point marks the transition from the solid physical state to a liquid or softened state.

In the case of partially crystalline materials, the melting point is the temperature at which the crystalline phase converts into the liquid state. The melting point of amorphous substances is the temperature at which the substance changes from the hard phase into a flexible phase, with the molecule chains becoming mobile without the plastic liquefying directly. This temperature is also called the glass transition temperature.

PEEK exhibits adequate chemical stability for most applications. The following comments in some cases therefore relate to PEEK as material example. However, a person skilled in the art is capable of applying the following disclosure to other plastics having a different viscosity, chemical stability, etc.

It is been found that, in addition to the chemical stability, an important role is also played by the pressure stability and viscosity of the plastics. If the plastic for the production of the porous moulding has excessively low viscosity, the mechanical stability is not present when, in particular, chromatographic separations are carried out. The porous moulding deforms.

Plastics having a viscosity between 1 and 700 mV 10 min (MVI) have typically proven suitable. Plastics having a viscosity between 5 and 550 ml/10 min (MVI), particularly preferably between 10 and 350 ml/10 min (MVI), are preferably suitable. These plastics may or may not comprise additives.

In a preferred embodiment, additives are added to the plastics before the production of the porous moulding by means of 3-D printing processes. These additives enable the viscosity of the plastics to be influenced, typically increased. It has furthermore been found that the addition of additives enables the surface properties of the plastics to be modified. For example, PEEK, as a porous sorbent, exhibits separation properties which correspond to a reversed phase material. If an additive in the form of SiO₂ particles is added to PEEK, the hydrophobic character of the plastic decreases. In addition, the Si—OH groups result in binding possibilities arising for functional groups. In addition, subsequent dissolving-out of the SiO₂ particles using alkaline solutions (for example NaOH) enables a further porosity hierarchy to be built up and thus the surface area in the framework of the mouldings to be increased.

Additives which are suitable in accordance with the invention are, for example, fibre materials, such as glass or carbon fibres, inorganic materials or pigments, for example chalk, talc, mica or inorganic oxides, such as silicon dioxide and aluminium oxide, or silicon carbide. The additives can be added, for example, in the form of fibres, irregularly or regularly shaped particles. In the case of regularly or irregularly shaped particles, the greatest diameter of the particles is typically between 1 and 25 μm.

Use is particularly preferably made in accordance with the invention of plastics which comprise, as additives, silicon dioxide, aluminium oxide, titanium dioxide, zirconium oxide, silicon carbide or mixtures of two or more of these additives.

Plastics have different viscosities, inter alia depending on their degree of crosslinking and their chain length. Addition of additives, such as, for example, fibres or particles, changes the viscosity of the substances again.

They become significantly more viscous. These aspects must be taken into account when selecting a plastic which is suitable in accordance with the invention.

The more additives are added to the plastics, the more brittle they become. An additive proportion between 1 and 50% (w/w), particularly preferably between 5 and 35% (w/w), is preferably added to the plastics.

The viscosity of thermoplastics is usually determined in the plastics-processing industry by means of the melt volume index (MVI) in accordance with DIN ISO 1133. The determination is carried out in a standardised apparatus. The central constituents thereof are a heatable, vertical cylinder (internal diameter 9.55 mm) with exit nozzle (internal diameter 2, mm, length 8.00 mm) and a matching piston with position markings (30.00 mm) (readable by the apparatus), which can be loaded with a weight. The apparatus contains precise measurement systems for the determination of the path length by which the piston has moved and for time and temperature measurement.

The viscosity of the plastics for the production of the mouldings according to the invention was determined using a method based on DIN ISO 1133, called the MVI method below:

In order to carry out the determination, the apparatus is pre-heated to a specified temperature of 380 C. The pre-dried (150° C., 12 h) plastic or plastic compound (6 g of powder or granules) is introduced into the cylinder and compacted. After the measurement temperature (380-° C.) has been reached, the material is left to stand for 240 s. The weight (10 kg) is then placed in position automatically and the melt allowed to flow out. Measurements begin when the lower position mark on the piston is recognised, and end when the upper mark is recognised. The melt volume index (MVI) is now determined via the instrument software from the path length through which the piston has moved, the measurement time intervals (2 s) and the known piston area and output in the customary unit ml/10 min.

The pre-drying time and temperature (150° C., 12 h), the sample mass (6 g), the measurement temperature (380° C.), the weight (10 kg) and the measurement time intervals (2 s) are standards which have been specifically oriented to the MVI determination of PEEK and PEEK compounds. The instrument geometry and the waiting time (240 s) are specified in DIN ISO 1133.

Addition of additives basically causes a higher viscosity, i.e. smaller MVI values compared with the MVI value of the starting polymer. It was found that, on addition of 10 to 30% (w/w) of SiO₂ additives, plastics having an initial viscosity of greater than 150 mV 10 min (MVI method), particularly preferably having MVI values between 300 and 700 mL/min, are preferably suitable. In the case of values below 150 ml/min by the MVI method, the plastics become very viscous after the compounding, in particular in the case of addition of 30% of additives or more.

For the production of the mouldings according to the invention, the plastics, if additives are to be added, are firstly compounded. This means that additives, such as, for example, fibres, particles, colourants, etc., are added to them. This is preferably carried out by controlled addition of the additives at the same time as processing via an extruder screw. More precise process parameters are known to the person skilled in the art and are given in handbooks, such as, for example, in Hensen, Knappe and Potente, “Handbuch der Kunststoffextrusionstechnik [Handbook of Plastics Extrusion Technology], Karl Hanse Verlag, (1986/1989).

During compounding, the later viscosity of the plastic is influenced by the type of the additives added and in some cases also by the time of the addition. In the case of early addition of, for example, fibres, these are comminuted during the compounding. For example, fibres having an initial length of 6 mm only have an average length of a few μm after compounding.

For processing by means of 3-D printing, the compounded or uncompounded plastics are used in liquid or pulverulent form, depending on the printing technique. The size of the powder particles also depends on the printing process employed. In the case of selective laser sintering, particle sizes between 20 and 250 μm are typically suitable.

The 3-D printing is carried out by the known methods described above.

The compilation of a CAD data set required for the 3-D printing is also known to the person skilled in the art. For example, STL or STEP files are suitable. For the production of the chromatography column according to the invention, the data set may, for example, only relate to the porous monolithic moulding or may also contain, for example, the cladding and/or connections for solvent inflow and outflow. The data set may describe an artificially constructed symmetrical moulding having a symmetrical pore structure. The data set may also describe the image of a moulding generated by means of chemical synthesis and thereby built up naturally in an irregular shape. CAD data sets of mouldings produced by means of chemical synthesis can be generated, for example, by means of computer tomography.

If only the porous monolithic moulding is produced by means of 3-D printing, this is preferably clad subsequently in a further step by known techniques.

For example, it can be introduced into a pressure-stable cladding of glass, metal or plastic

For use as chromatography column, the clad porous monolithic mouldings can then be provided with corresponding connections, filters, seals, etc. The cladding can terminate flush with the sorbent or project at the ends. Designs of this type are known for chromatography columns with particulate or monolithic sorbents.

The porous monolithic mouldings of the device according to the invention can in addition be subjected to further steps for increasing the surface area and/or derivatisation with separation effectors.

In order to increase, in particular, the internal surface area of the mouldings, they can be covered with a porous layer. In one embodiment, the moulding is to this end pre-treated with a solution or slurry. The solution consists of a monomer sol which contains alkoxysilanes. These alkoxysilanes are able to react with the internal surface of the moulding and/or can be polymerised to completion and/or sintered on there. In this way, a coating forms on the internal surface of the moulding, which increases the internal surface area due to its structure and modifies its chemical properties. Suitable alkoxysilanes are tetraalkoxysilanes (RO)₄Si, where R is typically an alkyl, alkenyl or aryl radical, such as C1 to C20 alkyl, C2 to C20 alkenyl or C5 to C20 aryl, preferably a C1 to C8 alkyl radical. Particular preference is given to tetraethoxy- and in particular tetramethoxysilane. Equally, the tetraalkoxysilane may contain various alkyl radicals.

In another embodiment, organoalkoxysilanes or mixtures of organoalkoxysilanes with tetraalkoxysilanes can be employed instead of an alkoxysilane or mixtures of two or more alkoxysilanes. Suitable organoalkoxysilanes are those in which one to three, preferably one, alkoxy groups of a tetraalkoxysilane have been replaced by organic radicals, such as preferably C1 to C20 alkyl, C2 to C20 alkenyl or C5 to C20 aryl. Further organoalkoxysilanes are disclosed, for example, in WO 03/014450 or U.S. Pat. No. 4,017,528. Instead of being employed in their monomeric form, the alkoxysilanes or organoalkoxysilanes can also be employed in pre-polymerised form as, for example, oligomers.

The tetraalkoxysilanes are typically employed as 2 to 50%, preferably 5 to 25% (% by weight) aqueous solution. Organoalkoxysilanes are typically employed as 2 to 25%, preferably 5 to 10% (% by weight) solution in an organic solvent, such as, for example, toluene. The treatment of the moulding is preferably carried out at elevated temperature between 50 and 150° C., for example is boiled under reflux in toluene. The duration of the treatment is generally between 1 to 48 hours, typically 2.5 to 24 hours.

In another embodiment, the solution additionally comprises particles and is thus a particle suspension or slurry. The particles typically have a diameter between 25 nm and 10 μm, preferably between 50 nm and 1 μm and typically consist of plastic, ceramic, glass or inorganic oxides, such as, for example, Ti, Al, Zr or Si oxides. They preferably have a hydrophilic surface. However, hydrophobically derivatised particles, for example containing C1-C20 alkyl radicals, are also particularly suitable if the monomer sol consists of organoalkoxysilanes and or mixtures of organoalkoxysilanes with alkoxysilanes. Due to hydrophobic interactions, the polymerisation preferably takes place here on the internal surface at the beginning.

The particles can be non-porous or porous. Spherical or also irregularly shaped particles are suitable. Particular preference is given to silica particles having a diameter between 50 nm and 1 μm.

In general, the mouldings are treated with the solution or slurry at temperatures between 25° C. and 100° C. for between 5 minutes and 24 hours. The treatment can be carried out by immersion of the entire moulding or rinsing or filling of the interior of the moulding. The mouldings are subsequently removed from the particle suspension or slurry and dried for several hours without further treatment.

In another embodiment, the internal surface of the mouldings is treated with reagents which have at least two, preferably three or four, functionalities. In accordance with the invention, suitable reagents having at least two functionalities are called bifunctional reagents. It is assumed that at least one functionality reacts with the surface of the moulding and at least one functionality is available for a further reaction, such as, for example, the binding of separation effectors.

Alkoxysilanes or organoalkoxysilanes, for example, are suitable here. Particular preference is given to
bis-functional silanes of the formula I

(RO)₁₋₃—Si—(CH₂)n-Si—(OR)₁₋₃ I

where R is typically an alkyl, alkenyl or aryl radical, such as C1 to C20 alkyl, C2 to C20 alkenyl or C5 to C20 aryl, preferably a C1 to C8 alkyl radical and n is preferably 1 to 8.

Examples of preferred compounds are BTME (bis(trimethoxygijyl) ethane where R=methyl and n=2)), bis(triethoxysilyl)ethane, bis(triethoxysilyl)methane and bis(triethoxysilyl)octane.
mono, di- or trifunctional alkoxysilanes having a fourth terminal function of the formula II

(RO)ₙR′ₘSi—R* II

where R and R′ is typically, independently of one another, an alkyl, alkenyl or aryl radical, preferably a C1 to C8 alkyl radical, and R* contains an —Si—OH-reactive group, such as an amino or epoxy group. This means that R* is, for example, alkylamino, alkenylamino or arylamino, preferably a C1 to C8 alkylamino or glycidoxyalkyl, glycidoxyalkenyl or glycidoxyaryl, preferably C1 to C8-glycidoxyalkyl. m is 0, 1 or 2, n+m adds up to 3. Examples of suitable compounds of the formula II are 3-glycidoxypropyltrimethoxysilane, 3-glycidoxypropylmethyldimethoxysilane or 3-glycidoxypropylmethyldiethoxysilane as well as 3-aminopropylmethyldiethoxysilane, 3-aminopropyldimethylethoxysilane or preferably 3-aminopropyltriethoxysilane or 3-aminopropyltrimethoxysilane.

The bifunctional reagents are typically employed as 2 to 25%, preferably 5 to 10% (% by weight) solution in an organic solvent, such as, for example, toluene. The treatment of the mouldings is preferably carried out at elevated temperature between 50 and 150° C.; for example is boiled under reflux in toluene. The duration of the treatment is generally between 5 minutes to 48 hours, typically 1 to 24 hours.

The treatment can be carried out by immersion of the entire moulding or rinsing or filling of the interior of the moulding. Finally, rinsing is generally carried out with an organic solvent.

Furthermore, it is possible to combine the said possibilities of surface activation.

The covalent bonding of separation effectors is generally carried out via the functional groups present on the moulding, such as, for example, hydroxyl groups, for example with formation of an ester or preferably an ether function, directly or via a linker or spacer. In another preferred embodiment, the linking to the base material is carried out via a cerium(IV)-catalysed graft polymerisation with formation of a C-C link to the base material. The functional groups present on the moulding, via which the bonding of the separation effectors takes place, can be, for example, groups of the thermoplastic polymer, functional groups of the additives or have been introduced by the surface activation described above.

Separation effectors are known to the person skilled in the art in the area of chromatography. Separation effectors are substituents which can be introduced already during the synthesis of the base material or subsequently into the sorbent and which have an influence on the surface properties of the sorbent. In particular, the specific derivatisation with separation effectors produces sorbents having certain chromatographic properties. In particular, separation effectors may contain the following terminal groups:
a) an ionic or ionisable group, for example

—NR⁷R⁸ or —N⁺R⁷R⁸R⁹,

in which
R⁷ and R⁸ independently of one another
H, alkyl having 1-5 C atoms
   and
   R⁹ alkyl having 1-5 C atoms
   with the proviso that, if X=—N⁺R⁷R⁸R⁹, R⁷ and R⁸ cannot be H,
guanidinium
SO₃⁻
carboxylic acids
b) a hydrophobic group, for example —OR¹⁰ or —NHR¹⁰, where R¹⁰ denote C₁-C₂₀-alkyl, C₆-C₂₅-aryl, C₇-C₂₅-alkylaryl or C₇-C₂₅-arylalkyl, and where these radicals may also have been derivatised with nitrile or C₁₋C₅-alkoxy, and where, in addition, one or more non-adjacent CH₂ groups may have been replaced by NH or O or, in addition, one or more CH groups may have been replaced by N;
c) a metal chelate group;
d) a thiophilic radical;
e) a chiral radical.
f) biomolecules, such as proteins (for example antibodies), peptides, amino acids, nucleic acids, saccharides, biotin etc.

Thiophilic radicals are disclosed, for example, in EP 0 165 912.

If it is intended that the polymer is firstly provided with a universal linker, it can, for example for the introduction of epoxy groups, be reacted with glycidyl compounds, such as butanediol diglycidyl ether.

Furthermore, the porous monolithic moulding of the device according to the invention as base material can be provided by graft polymerisation with tentacle-like structures, which may in turn carry the corresponding separation effectors or may be functionalised therewith. The grafting is preferably carried out in accordance with EP 0 337 144. The chain produced is linear and linked to the base material via a monomer unit. To this end, the base material according to the invention is suspended in a solution of monomers, preferably in an aqueous solution. The grafting-on of the polymeric material is effected in the course of a conventional redox polymerisation with exclusion of oxygen. The polymerisation catalyst employed is cerium(IV) ions, since this catalyst forms free-radical sites on the surface of the base material from which the graft polymerisation of the monomers is initiated. The polymerisation is terminated by termination reactions with participation of the cerium salts. For this reason, the (average) chain length can be influenced by the concentration ratios of the base material, of the initiator and of the monomers. Furthermore, uniform monomers or also mixtures of various monomers can be employed; in the latter case, grafted copolymers form.

The chromatography columns according to the invention can be produced in all usual sizes for analytical or preparative chromatography. They are suitable for carrying out chromatographic separations of two or more substances and can also be employed as pre-column. For analytical chromatography, the diameters of the porous monolithic mouldings are typically between 0.5 mm and 10 cm, the lengths are between 0.5 cm and 50 cm. For preparative application, it is also possible to produce mouldings having larger dimensions.

If the cladding of the chromatography column is produced by means of 3-D printing together with the porous moulding, it then typically has a wall thickness of between 1 and 10 mm, preferably between 1 and 5 mm. Similar wall thicknesses are also suitable for devices for sample preparation, such as, for example, devices for extraction.

The chromatography columns according to the invention exhibit good separation properties. Even after storage in solvents and frequent use, no or only slight impairment of the separation efficiencies is evident. In particular in the case of chromatography columns whose cladding has been produced directly at the same time by means of 3-D printing, good pressure stability is evident. It has furthermore been found that the columns according to the invention made from thermoplastics also facilitate chromatographic separations at temperatures above 30° C. PEEK, for example, has a melting point of above 340° C. and is thus suitable, depending on derivatisation with additives and separation effectors, for chromatographic separations, for example, up to 150° C., so that chromatographic separation in the gas phase is also possible with the columns according to the invention.

Even without further comments, it is assumed that a person skilled in the art will be able to utilise the above description in the broadest scope. The preferred embodiments and examples should therefore merely be regarded as descriptive disclosure which is absolutely not limiting in any way.

The complete disclosure content of all applications, patents and publications cited above and below, in particular of the corresponding application EP 15001559.2, filed on 22 May 2015, is incorporated into this application by way of reference.

### EXAMPLES

### 1) Creation of a CAD File:

Porous slice elements are constructed on the screen by means of suitable software. These porous slice elements are then arranged offset one above the other until they produce a porous column of defined dimension (for example 50-3 mm or 100×4.6 mm).

### 2) Performance of the 3-D Printing:

By means of the CAD file created in accordance with Example 1), the pre-specified structural elements are manufactured using a suitable PEEK raw material (for example EOS PEEK HP3) in an EOS 3-D printer (EOSINT P800).

EOSINT P800: This unit is used for the printing and manufacture of “high performance plastic components”. This printer uses the principle of selective laser sintering SLS. The PEEK raw material is built up layer by layer and the particles are melted by laser in each layer.

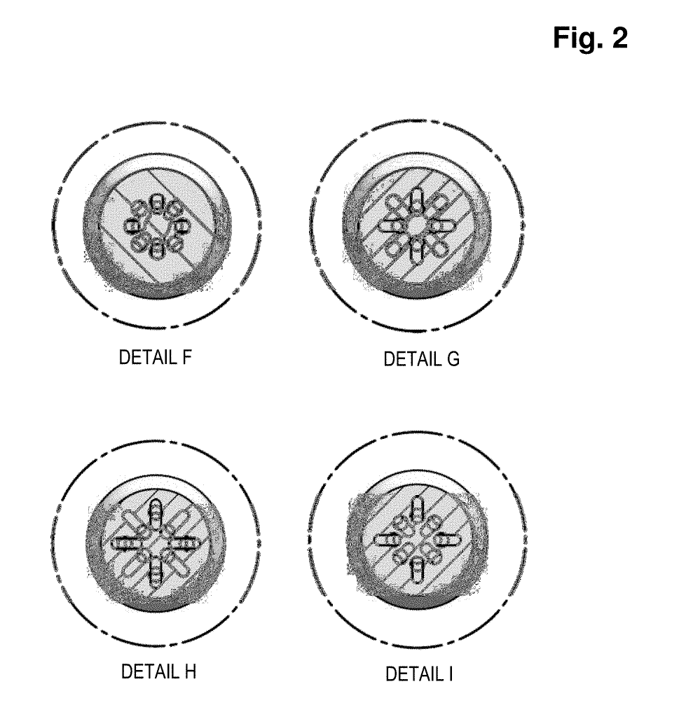

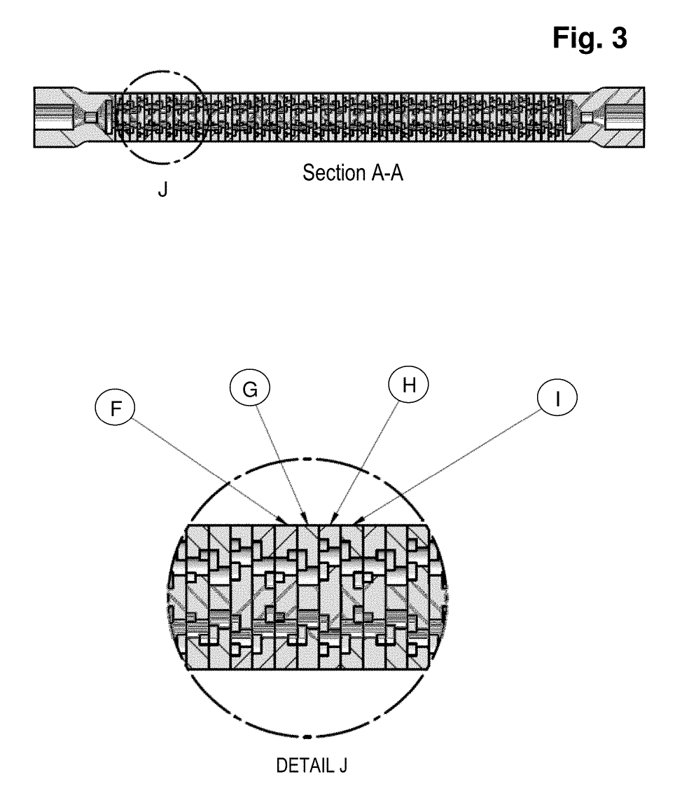

FIGS. 1 to 3 show diagrammatically sections of the CAD file created. FIG. 1 shows the entire chromatography column with connections for solvent inflow and outflow. The build-up from layers is evident. The sections or layers B-B, C-C, D-D and E-E are drawn in in the column. The individual drawings show the pore structure of the respective layers. FIG. 2 shows these sections once again in larger format. Detail F here shows section B-B from FIG. 1 denoted by F, detail G shows section C-C denoted by G, etc. FIG. 3 shows the entire column of dimension 50×3 mm once again, where the internal structure is depicted diagrammatically in a longitudinal section. Section J with layers C-C (F), D-D (G), E-E (H) and F-F (I) shown in FIGS. 1 and 2 is emphasised once again in enlarged form.

3) Chromatoaraohic Separations—Comparison with Monolithic RP18 Column

A comparison is carried out of the column of dimension 50×3 mm produced by means of 3-D printing in accordance with Example 2 (column A) with a Chromolith® RP 18e column (Merck KGaA, Darmstadt) of the same dimension (column B).

### Elution Conditions:

eluent: ACN/water (20/80 in the case of column A) and (35/65 in the case of column B)
flow rate: 1.0 ml/min
det.: UV254 nm Response fast;
temp.: RT
injvol.: 1 μl;
sample: thiourea and triphenylene dissolved in eluent

FIG. 4 shows the chromatograms obtained. In both cases, base line separation of the two substances can be produced.

Further details on the separations are given in Tables A and B below. Table A shows the results with column A, Table B shows the results for column B.

TABLE A

| Ret. Time min | Peak name | K′ | Asym(USP) | Plates(USP) |
|---|---|---|---|---|
| 0.257 | Thiourea | 0.00 | 1.87 | 39 |
| 1.870 | Triphenylene | 6.28 | 2.92 | 8 |

TABLE B

| Ret. Time min | Peak name | K′ | Asym(USP) | Plates(USP) |
|---|---|---|---|---|
| 0.312 | Thiourea | 0.00 | 1.78 | 459 |
| 1.853 | Triphenylene | 4.94 | 2.44 | 1569 |

### 4. Influence of the Eluent

Chromatographic separations with various eluent compositions are carried out with the chromatography columns of the dimension 50×3 mm produced in accordance with Example 2.

### Elution Condition A:

thiourea+triphenylene 1:1
eluent: ACN/water 80/20
cond.: 1.0 ml/min, UV254 nm, RT
injvol.: 2 μl
sample: thiourea+triphenylene in eluent

### Elution Condition B:

thiourea+triphenylene 1:1
eluent: ACN/water 20/80
cond.: 1.0 ml/min, UV254 nm, RT
injvol.: 2 μl
sample: thiourea+triphenylene in eluent

FIG. 5 shows the chromatograms obtained under condition A and B. It is found that co-elution of the two substances thiourea and triphenylene occurs in the case of eluent A (ACN/water (80/20; V/V), whereas separation is obtained with eluent B (ACN/water (20/80; V/V).

### 5. Gradient Separation:

A gradient separation is carried out with the chromatography columns of the dimension 50×3 mm produced in accordance with Example 2, with the following conditions:
thiourea+triphenylene 1:1
eluent: ACN/water 10/90 in 10 min to 20/80
cond.: 1.0 ml/min, UV254 nm, RT
injvol.: 2 μl
sample: thiourea+triphenylene in eluent

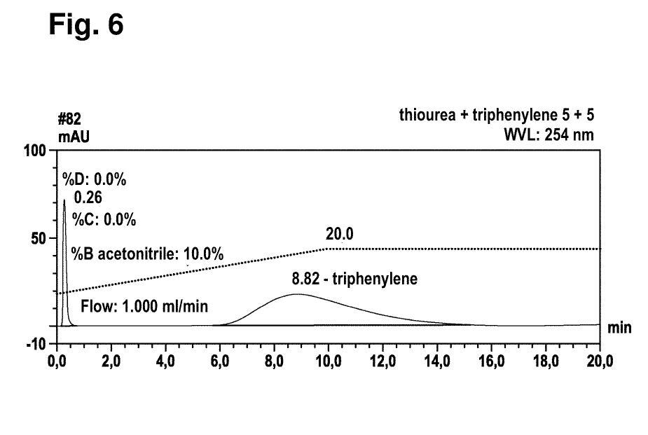

FIG. 6 shows the chromatogram obtained.

It is found that gradient elution enables greater separation of the two substances to be obtained. Thus, the 3-D-printed PEEK column behaves chromatographically like an RP column.

### 6. Influence of the Temperature

A chromatographic separation is carried out at various temperatures with the chromatography columns of the dimension 50×3 mm produced in accordance with Example 2:

### Elution Conditions:

eluent: methanol/water 30/70
cond.: 1.0 ml/min, UV254 nm, RT
injvol.: 2 μL
sample: thiourea+triphenylene in eluent

The separations are carried out at 20° C., 40° C., 60° C. and 80° C.

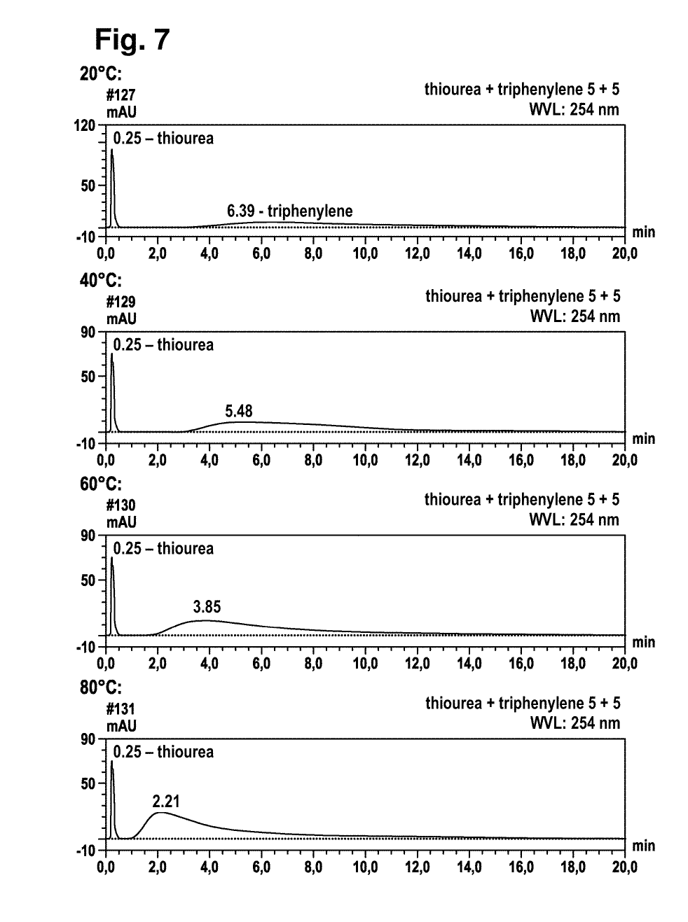

The chromatograms obtained are shown in FIG. 7.

When the temperature is increased, the retention times shorten due to accelerated mass transfer. This corresponds to the behaviour to be expected in chromatography.

### 7. Performance of 3-D Printing for a Chromatography Column of the Dimension 100×4.6 mm:

By means of the CAD file created in accordance with Example 1), the pre-specified structural elements are manufactured using a suitable PEEK raw material (for example EOS PEEK HP3) in an EOS 3-D printer (EOSINT P800).

This printer uses the principle of selective laser sintering SLS. The PEEK raw material is built up layer by layer and the particles are melted by laser in each layer.

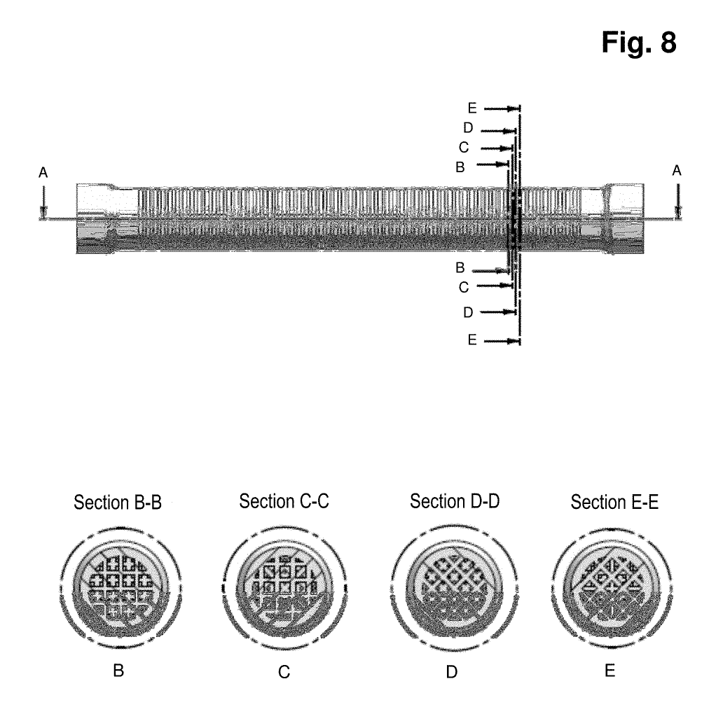

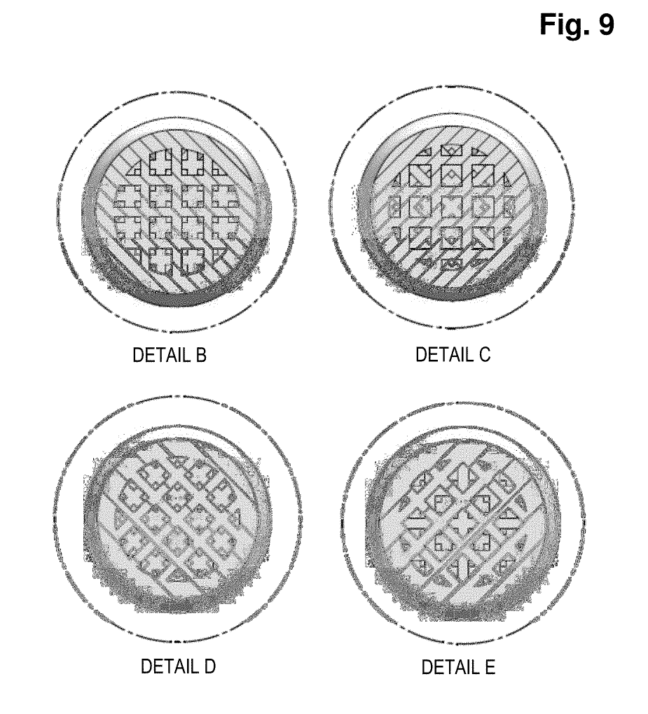

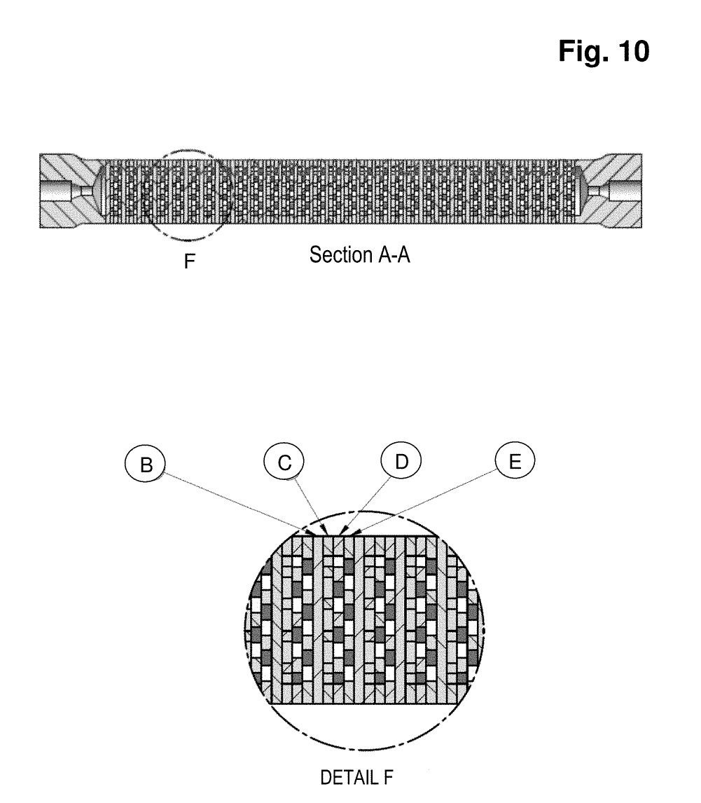

FIGS. 8 to 10 show diagrammatically sections of the CAD file created. FIG. 8 shows the entire chromatography column with connections for solvent inflow and outflow. The build-up from layers is evident. The sections or layers B-B, C-C, D-D and E-E are drawn in in the column. The individual drawings show the pore structure of the respective layers. FIG. 9 shows these sections once again in larger format. Detail B here shows section B-B from FIG. 8 denoted by B, detail C shows section C-C denoted by C, etc. FIG. 10 shows the entire column of the dimension 100×4.6 mm once again, where the internal structure is depicted diagrammatically in a longitudinal section. Section F with layers B-B (B), C-C (C), D-D (D) and E-E (E) shown in FIGS. 8 and 9 is emphasised once again in enlarged form.

### 8. Chromatoaraohic Separation of a Substance Mixture on Five 3-D PEEK Columns (100×4.6 mm) Coupled to an Overall Column of the Dimension 500×4.6 mm

A chromatographic separation is carried out with the chromatography columns of the dimension 100×4.6 mm produced in accordance with Example 7. Five columns are coupled together here.

### Elution Conditions:

eluent: ACN/water 20/80
cond.: 1.0 ml/min, UV254 nm,
temp.: RT
injvol.: 1 μl
sample: thiourea, o-terphenyl, triphenylene in eluent

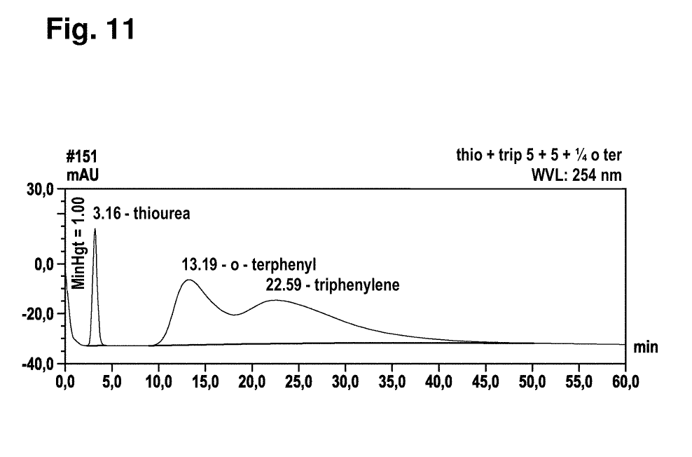

The chromatogram obtained is depicted in FIG. 11. Separation of the 3 substances can be achieved.

Further data can be found in Table C:

TABLE C

| No. | Ret. Time min | Peak name | K′ | Asym(USP) | Plates(USP) |
|---|---|---|---|---|---|
| 1 | 3.160 | Thiourea | 0.00 | 1.05 | 186 |
| 2 | 13.187 | o-Terphenyl | 3.17 | n.a. | 18 |
| 3 | 22.592 | Triphenylene | 6.15 | n.a. | 8 |

1. Device for substance separation at least comprising a porous monolithic moulding as sorbent and optionally a cladding, characterised in that the moulding has been produced from a thermoplastic polymer by means of 3-D printing processes.

2. Device for substance separation according to claim 1, characterised in that the thermoplastic polymer is selected from the group of the polyether imides, polyarylates, polyether ketones, polyesters, polyamides, polyimides, polyamide imides, polybenzimidazoles, polyphenylene sulfides, polyphenyl sulfones or polyoxymethylene as well as mixtures of two or more of these materials.

3. Device according to claim 1, characterised in that the melting point of the thermoplastic polymer is greater than 150° C.

4. Device according to claim 1, characterised in that the thermoplastic polymer is PEEK or polyphenylene sulfide.

5. Device according to claim 1, characterised in that the device is a chromatography column.

6. Device according to claim 1, characterised in that the thermoplastic polymer comprises additives.

7. Device according to claim 1, characterised in that the additives are fibre materials, inorganic materials, pigments or inorganic oxides or mixtures thereof.

8. Device according to claim 1, characterised in that the device consists at least of a porous monolithic moulding and a cladding which have been produced by means of 3-D printing processes.

9. Device according to claim 1, characterised in that the porous monolithic moulding has a bimodal or oligomodal pore distribution.

10. Device according to claim, 1, characterised in that the porous monolithic moulding has macropores having a diameter between 0.1 and 10,000 μm which serve as through-flow pores, and mesopores having a pore diameter between 2 and 500 nm.

11. Device according to claim 1, characterised in that the porous monolithic moulding is columnar and the cladding is a tube which surrounds the moulding at least on the column wall

12. Device according to claim 1, characterised in that the porous monolithic moulding has been modified by means of separation effectors.

13. A method for separation of the least two substances comprising separating said substances in a device according to claim 1.

14. The method according to claim 13, characterised in that the separation takes place chromatographically.

15. The method according to claim 14, characterised in that the chromatographic separation takes place at temperatures above 30° C.
